(19) United States
(12) Patent Application Publication
(10) Pub. No.: US 2009/0225705 A1
(43) Pub. Date: Sep. 10, 2009

(54) Apparatus and Method for Negotiating Quality of Service

(76) Inventors: Hye-Yeon Kwon, Daejeon (KR); Hyung-Cheol Shin, Daejeon (KR); Jae-Wook Shin, Daejeon (KR); Kwang-Hyun Ro, Daejeon (KR); Kwang-Ryul Jung, Daejeon (KR); Kyung-Yul Cheon, Daejeon (KR); You-Sun Hwang, Daejeon (KR); Ae-Soon Park, Daejeon (KR)

Correspondence Address: STAAS & HALSEY LLP, SUITE 700, 1201 NEW YORK AVENUE, N.W., WASHINGTON, DC, 20005, US

(21) Appl. No.: 11/922,847

(22) PCT Filed: Jun. 22, 2006
(86) PCT No.: PCT/KR2006/002415

§ 371 Date: Dec. 26, 2007

(30) Foreign Application Priority Data
Jun. 22, 2005 (KR) 10-2005-0054168
Jun. 7, 2006 (KR) 10-2006-0050828

(51) Int. Cl. H04W 28/24

(52) U.S. Cl. 370/329

(57) ABSTRACT

The present invention discloses a gateway and a terminal negotiating a QoS in a network interworking system. The terminal negotiates a QoS with a WLAN access point and establishes a WLAN access bearer. In addition, the terminal negotiates a QoS with the gateway for packet exchange through the WLAN access bearer. The gateway accepts a QoS according to a QoS of an external bearer, and the terminal and the gateway establish an I-WLAN bearer. Subsequently, the terminal negotiates a QoS with the gateway for packet exchange with an end terminal through the I-WLAN bearer. The gateway accepts the QoS depending on available resources of the external and I-WLAN bearers, and the terminal and the gateway establish an IP bearer.

### TECHNICAL FIELD

The present invention relates to a method for negotiating a quality of service (QoS) and an apparatus using the same. Particularly, the present invention relates to a gateway and user equipment that negotiate a QoS in a network interworking system.

Since a digital cellular-based second generation mobile communication system has emerged, an International Mobile Telecommunication 2000 (IMT-2000) which is a third generation (3G) mobile communication was specified as the standard protocol for providing high quality worldwide multimedia services by the International Telecommunication Union (ITU). The 3G mobile communication system provides global roaming by using a consistent wireless access scheme with a single frequency bandwidth so that users can obtain services anytime and anywhere, and also provides wireless multimedia services such as a conventional voice service, images, moving pictures, a video phone, and Internet access by supporting up to 2 Mbps transmission speed with high bandwidth.

An initial goal of the standardization is to complete a single, worldwide system standard. Unfortunately, the process of unifying the numerous international standards has proved to be extremely difficult. The 3G mobile communication system is now broadly divided into a Universal Mobile Telecommunication System (UMTS) for Europe and Japan and a Code Division Multiple Access 2000 (CDMA-2000) for America.

The standardization work for CDMA-2000 is being carried out under the supervision of the Third Generation Partnership Projects 2 (3GPP2). The CDMA-2000 uses a North American Standard Interim Standard (ANSI)-41-based network protocol as a core network, and utilizes a synchronous network scheme as an interface for synchronization between base stations.

The standardization work for the UMTS is being carried out under the Third Generation Partnership Project (3GPP). The UMTS uses a Global System for Mobile Communications (GSM) based mobile application part (GSM-MAP) as a core network, and utilizes an asynchronous network scheme as an air interface since synchronization between base stations is not required.

The 3GPP uses the concept of Release in the evolution of the system standardization, and 3GPP wireless local area network (WLAN) interworking is one of the main issues that have been developed in Release 6. The purpose of the 3GPP WLAN interworking is to provide 3GPP service and functions to a user in a WLAN. Although the standardization of the 3GPP WLAN is being carried out, a QoS negotiation method in the 3-GPP WLAN interworking system has not been proposed.

The 3G mobile communication system provides a packet-switched service rather than a circuit-switched service. In the packet-switched network, a communication message is broken into data units, called packets. Each packet is routed through a network based on the destination address contained in each packet. Particularly, the 3G mobile communication system is an all-IP network that enables the nodes of the network to communicate with each other based on an Internet protocol (IP), and a communication message is exchanged through the IP in the 3G mobile communication system. In the packet-switched network, a communication message is broken into a plurality of packets and thus a plurality of users can share the same channel within the network.

In the case that the same types of packets are input to a node in the network, the node can apply the same priority or policy to the input packets or to a group of packets. This is called a best effort scheme. However, the best effort scheme cannot provide a quality of service (QoS) that is adequate for each packet since there is a limit in bandwidth extension in the present network, and different types of packets such as a video phone, broadcasting, multimedia, and voice over IP (VOIP) are handled.

Particularly, the 3G mobile communication service has been developed for providing various services including voice service, image and moving pictures, a video phone, and Internet access, and therefore, standardization for QoS is demanded. However, as previously mentioned, a method for negotiating a QoS in the 3-GPP WLAN interworking system has not been proposed yet.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a gateway and a terminal negotiating a quality of service (QoS) in a network interworking system, and a QoS negotiation method thereof.

### Technical Solution

An exemplary gateway according to an embodiment of the present invention includes a core network, a first bearer manager, a second bearer manager, a third bearer manager, and a controller. The core network connects a wireless access network and a packet switched service network, and the first, second, and third bearer managers enable communication between the core network and the packet switched service network. The first bearer manager manages a first bearer packet exchange with an end terminal included in the packet switched service network. The second bearer manager manages a second bearer for packet exchange with a terminal accessing the wireless access network. The third bearer manager manages a third bearer for packet exchange between the terminal and the end terminal. The controller determines whether to accept a first QoS requested by the terminal for establishing the third bearer through the second bearer in accordance with an available resource of the first bearer.

The controller determines whether to accept the first QoS in accordance with available resources of the first and second bearers.

An exemplary terminal according to an embodiment of the present invention exchanges a packet with a packet switched service network connected with a wireless access network through a core network, and includes a first bearer manager, a second bearer manager, and a controller. The first bearer manages a first bearer for packet exchange with an end terminal included in the packet switched service network, and the second bearer manager manages a second bearer for packet exchange with an end terminal included in the packet switched service network. In addition, the controller manages a resource allocated to the first bearer. The second bearer manager inquires to the controller whether to accept the first QoS for establishing the second bearer, the controller determines whether to accept the first QoS in accordance with an available resource of the first bearer, and the second bearer manager requests the first QoS from the gateway through the first bearer when the controller accepts the first QoS.

An exemplary quality of service (QoS) negotiation method according to an embodiment of the present invention is used by a gateway that enables communication between a core network and a packet switched service network, the core network connecting a wireless access network and the packet switched service network. In the method, the gateway establishes a first bearer for packet exchange with an end terminal included in the packet switched service network. Subsequently, the gateway receives a first QoS requested by a terminal for establishing a second bearer for packet exchange with the gateway, the terminal accessing the wireless access network. Then the gateway accepts the first QoS when the first QoS is adequate for a QoS of the first bearer. The gateway establishes a second bearer when the first QoS is accepted.

Herein, the gateway receives a second QoS requested by the terminal for establishing a third bearer for packet exchange with the end terminal through the second bearer, accepts the second QoS when the second QoS is adequate for an available resource of the first bearer, and establishes the third bearer when the second QoS is accepted.

An exemplary quality of service (QoS) negotiation method according to another exemplary embodiment of the present invention is used by a terminal that exchanges a packet with a packet switched service network connected with a wireless access network through a core network. The terminal requests a first QoS to the wireless access device for establishing a first bearer for packet exchange with a wireless access device included in the wireless access network. Then the terminal establishes the first bearer when the wireless access device accepts the first QoS. Subsequently, the terminal requests a second QoS to a gateway through the first bearer for establishing a second bearer for packet exchange with the gateway, wherein the gateway enables communication between the core network and the packet switched service network. Then the terminal establishes the second bearer when the gateway accepts the second QoS.

Herein, the terminal requests a third QoS from the gateway through the second bearer for establishing a third bearer for packet exchange with an end terminal included in the packet switched service network, and establishes the third bearer when the gateway accepts the third QoS.

### Advantageous Effects

According to the present invention, WLAN user equipment exchanges a data packet with an end terminal in the 3GPP packet-switched service network through efficient QoS negotiation.

Particularly, the WLAN user equipment negotiates with a packet data gate for establishing an IP bearer for packet exchange with the end terminal so that efficient QoS negotiation can be achieved.

### DESCRIPTION OF DRAWINGS

FIG. 1 shows A 3GPP-wireles local area network (WLAN) interworking system according to an exemplary embodiment of the present invention.

FIG. 2 shows a QoS management function for a WLAN 3GPP IP connection according to an exemplary embodiment of the present invention.

FIG. 3 is a flowchart of an IP bearer establishment process of WLAN user equipment according to an exemplary embodiment of the present invention.

FIG. 4 is a flowchart of a QoS negotiation process of a packet data gateway according to an exemplary embodiment of the present invention.

FIG. 5 is a flowchart of a QoS negotiation process of WLAN user equipment according to an exemplary embodiment of the present invention.

FIG. 6 shows a QoS management function for a WLAN direct IP connection according to an exemplary embodiment of the present invention.

### BEST MODEL

An exemplary embodiment of the present invention will hereinafter be described in detail with reference to the accompanying drawings.

In the following detailed description, only a certain exemplary embodiment of the present invention has been shown and described, simply by way of illustration. As those skilled in the art would realize, the described embodiment may be modified in various different ways, all without departing from the spirit or scope of the present invention. The drawings and description are to be regarded as illustrative in nature and not restrictive, and life reference numerals designate like elements through the specification.

Throughout this specification and the claims which follow, unless explicitly described to the contrary, the word “comprising” or variations such as “comprises” will be understood to imply the inclusion of stated elements but not the exclusion of any other elements.

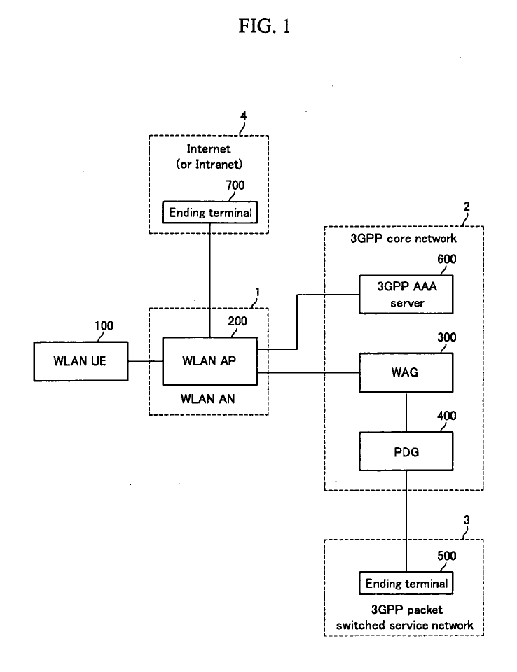

A Third Generation Partnership Project (3-GPP) wireless local area network (WLAN) interworking system according to an exemplary embodiment of the present invention will now be described in detail with reference to FIG. 1.

FIG. 1 shows a 3GPP-WLAN interworking system according to an exemplary embodiment of the present invention.

As shown in FIG. 1, the 3-GPP WLAN interworking system includes WLAN user equipment (WLAN UE) 100, a WLAN access network (WLAN AN) 1, a 3GPP core network 2, a 3GPP packet-switched service network 3, and an Internet (or Intranet) 4.

The WLAN UE 100 is a user terminal registered with the 3GPP packet-switched service network 3 and is able to access the WLAN AN 1. The WLAN UE 100 may access only the WLAN AN 1 or access both the WLAN AN1 and a 3GPP access network. Herein, the 3GPP access network includes a Node-B that provides wireless code division multiplexing access (WCDMA) wireless access and a radio network controller (RNC) that controls the Node-B. A terminal that can access the 3GPP access network accesses the 3GPP packet-switched service network 3 through the 3GPP access network. The WLAN UE 100 may be provided as a mobile device, a laptop computer, a notebook computer, or a PDA having a WLAN card, or may be provided as a mobile device, a laptop computer, a notebook computer, or a PDA having a WLAN card and a 3GPP access module.

The WLAN AN 1 provides WLAN access to the WLAN UE 100, and includes a plurality of WLAN access points (WLAN APs) 200, each of which wirelessly accesses the WLAN UE 100. The WLAN used in the present invention is based on a wireless LAN specified by the IEEE 802.11 WLAN standard, but that is not restrictive. Therefore, the WLAN AN 1 may be provided as a typical wireless access network, and the WLAN AP 200 may be provided as a base station or a wireless access terminal that corresponds to a Node-B.

The 3GPP core network 2 is a core network that connects the WLAN AN 1 and the 3GPP packet-switched service network 3. The 3GPP core network 2 includes a WLAN access gateway (WAG) 300, a packet data gateway (PDG) 40, and a 3GPP Authentication Authorization Accounting Server (3GPP AAA Server) 60.

The WAG 300 is a gateway via which data is exchanged between the WLAN access network 1 and the 3GPP core network 2. Since the WLAN AN 1 has a protocol that is different from that of the 3GPP core network 2, the WAG 300 changes protocols for data exchange between the WLAN AN 1 and the 3GPP core network 2.

The PDG 400 is a gateway via which data is exchanged between the 3GPP core network 2 and the 3GPP packet-switched service network 3. Since the 3GPP core network 2 has a protocol that is different from that of the 3GPP packet-switched service network 3, the PDG 40 changes protocols for data exchange between the 3GPP core network 2 and the 3GPP packet-switched service network 3.

The 3GPP packet-switched service network 3 is a standard packet-switched service network specified by the 3GPP, and provides a 3GPP packet-switched service to the WLAN UE 100. The WLAN UE 100 is provided with the 3GPP packet-switched service from the 3GPP packet-switched service network 3 via the WLAN AN 1 and the 3GPP core network 2, and this is typically called WLAN 3GPP IP access. An ending network node (e.g., a server) included in the 3GPP packet-switched service network 3 and providing the 3GPP packet-switched service to the WLAN UE 100 is called a 3GPP end terminal 50.

The WLAN UE 100 directly accesses the Internet 4 through the WLAN AN 1 and receives IP-based services, and this is called WLAN direct IP access. The Internet 4 includes an Internet end terminal 70 that provides the IP-based service.

The 3GPP AAA server 60 is a server handling user authorization, service authentication, and billing data. The WLAN UE 100 is registered with the 3GPP AAA server 60 for WLAN 3GPP IP access or WLAN direct IP access. In addition, the 3GPP AAA server 60 charges for a QoS served to the WLAN UE 100 and network and bandwidth usages.

The Internet 4 is a packet-switched service network, and includes an Internet end terminal 700 that provides Internet services.

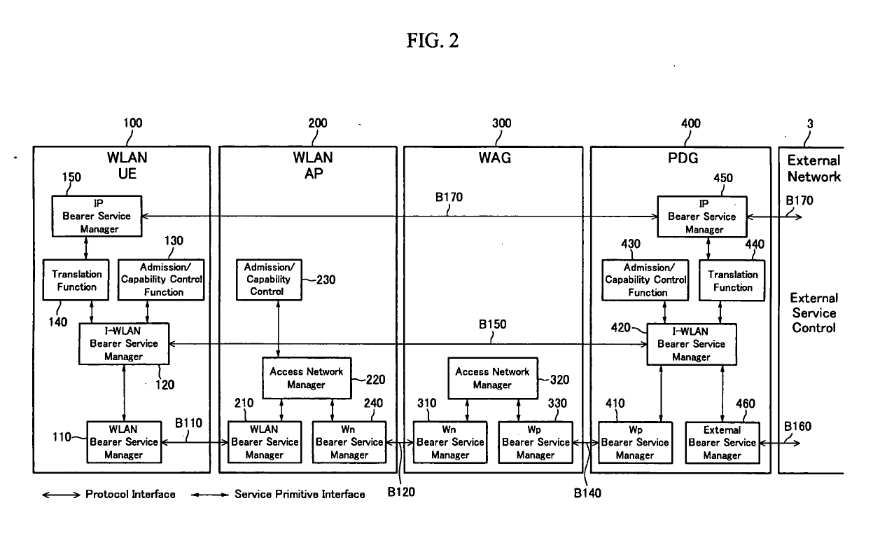

A QoS management function for establishing a WLAN 3GPP IP connection according to an exemplary embodiment of the present invention will be described with reference to FIG. 2.

FIG. 2 shows a QoS management function for establishing a WLAN 3GPP IP connection according to an exemplary embodiment of the present invention.

As shown in FIG. 2, the WLAN UE 100 includes a WLAN bearer service manager 110, an Interworking WLAN (I-WLAN) bearer service manager 120, an admission and capability controller 130, a converter 140, and an IP bearer service manager 150. In addition, the WLAN AP 200 includes a WLAN bearer service manager 210, an access network manager 220, an admission and capability controller 230, and a Wn bearer service manager 240. The WAG 300 includes a Wn bearer service manager 310, an access network manager 320, and a Wp bearer service manager 330. The PDG 400 includes a Wp bearer service manager 410, an I-WLAN bearer service manager 420, an admission and capability controller 430, a converter 440, an IP bearer service manager 450, and an external bearer service manager 460.

Interfaces between constituent elements of the WLAN UE 100 are as follows. The I-WLAN bearer service manager 120 exchanges data with the WLAN bearer service manager 110, the admission and capability controller 130, and the converter 140 through an internal service primitive. The converter 140 exchanges data with the I-WLAN bearer service manager 120 and the IP bearer service manager 150 also through an internal service primitive.

The internal service primitive indicates an interface function for exchanging data between layer modules, and includes a request primitive, an indication primitive, a response primitive, and a confirm primitive. The request primitive is used when an upper layer requests a service from a lower layer. The indication primitive is used when the lower layer informs an arrival of a request from a communication counterpart to the upper layer. The response primitive is used when the upper layer transmits a response to the lower layer in response to the indication primitive. The confirm primitive is used when the lower layer transmits a response to the upper layer in response to the request primitive.

Since interfaces between constituent elements of the WLAN AP 200, the WAG 300, and the PDG 400 are shown in FIG. 2, descriptions related thereto will not be further provided.

A method for establishing a WLAN bearer B110 will be described.

The WLAN bearer service manager 110 of the WLAN UE 100 negotiates a QoS for establishing the WLAN bearer B110 with the WLAN bearer service manager 210 of the WLAN AP 200. The WLAN bearer B110 is used for packet exchange between the WLAN UE 100 and the WLAN AP 200. The admission and capability controller 230 of the WLAN AP 200 maintains information on resources allocated to the WLAN bearer B110 and an available resource of the WLAN bearer B110. When the WLAN bearer service manager 110 requests QoS negotiation for establishing the WLAN bearer B110, the WLAN bearer service manager 210 inquires to the admission and capability controller 230 whether the admission and capability controller 230 accepts the QoS requested by the WLAN bearer service manager 110 through the access network manager 220. The admission and capability controller 230 determines whether to accept the request in accordance with the available resource of the WLAN bearer B110. When the admission and capability controller 230 rejects the request, the WLAN bearer service manager 110 and the WLAN bearer service manager 210 perform renegotiation.

When the admission and capability controller 230 accepts the QoS, the WLAN bearer service manager 110 and the WLAN bearer service manager 210 generate, manage, and maintain the WLAN bearer B110 for supporting the negotiated QoS. At this time, the I-WLAN bearer service manager 120 receives information on the negotiated QoS and information on resources allocated to the WLAN bearer B110 and transmits the received information to the admission and capability controller 130. The admission and capability controller 130 maintains and manages information on a QoS supported by the WLAN bearer B110 and information on the resource allocated to the WLAN bearer B110.

The Wn bearer service manager 240 of the WLAN access point 200 and the Wn bearer service manager 310 of the WAG 300 generate, manage, and maintain a Wn bearer B120. According to the exemplary embodiment of the present invention, a service of the Wn bearer B120 follows a best effort scheme. According to the best effort scheme, the same priority or the same policy is applied to packets or a group of packets.

The Wp bearer service manager 330 of the WAG 300 and the Wp bearer service manager 410 of the PDG 400 generate, manage, and maintain a Wp bearer B140. In the present embodiment, a service of the Wn bearer B140 is based on the best effort scheme.

The external bearer service manager 460 establishes, manages, and maintains an external bearer B160, used for packet exchange between the PDG 400 and the end terminal 500. At this time, the I-WLAN bearer service manager 420 receives information on a QoS of the external bearer B160 or information on a resource allocated to the external bearer B160 from the external bearer service manager 460 and transmits the received information to the admission and capability controller 430. The admission and capability controller 430 maintains and manages the information on the QoS of the external bearer B160 or information on the resource allocated to the external bearer B160.

The access network manager 220 of the WLAN access point 200 enables communication between the WLAN bearer service manager 210 and the Wn bearer service manager 240. That is, the access network manager 220 receives contents of a message that the WLAN bearer service manager 210 has received from the WLAN bearer service manager 110 by using an internal service primitive

The access network manager 220 transmits the contents received from the WLAN bearer service manager 210 to the Wn bearer service manager 240 by using the internal service primitive. Then, the Wn bearer service manager 240 generates a message that includes the received contents, and provides the message to the Wn bearer service manager 310 of the WAG 300 by using a service of the Wn bearer B120. Also, reversely, the access network manager 220 provides the internal service primitive transmitted from the Wn bearer service manager 240 to the WLAN bearer service manager 210.

The access network manager 220 of the WLAN access point 200 interworks with the admission and capability controller 230. That is, when receiving the internal primitive, including whether or not to accept a QoS request of the WLAN bearer service manager 110, from the WLAN bearer service manager 210, the access network manager 220 transmits the corresponding internal primitive to the admission and capability controller 230. When receiving the internal primitive, including a result of the acceptance of the requested QoS, from the admission and capability controller 230, the access network manager 220 provides the corresponding internal primitive to the WLAN bearer service manager 210.

The access network manager 320 of the WAG 300 enables communication between the Wn bearer service manager 310 and the Wp bearer service manager 330. A role of the access network manager 320 can be easily derived from the access network manager 220, and therefore, a further description will be omitted.

A method for establishing an I-WLAN bearer B150 will now be described.

The I-WLAN bearer service manager 120 of the WLAN UE 100 negotiates a QoS for establishing an I-WLAN bearer B150 with the I-WLAN bearer service manager 420 and establishes the I-WLAN bearer B150. The I-WLAN bearer B150 is used for packet exchange between the WLAN UE 100 and the PDG 400. Since it is preferred that a QoS between the WLAN UE 100 and the PDG 400 does not exceed the QoS provided from the WLAN bearer, the I-WLAN bearer service manager 120 refers to a QoS of the WLAN bearer B110 or the available resource of the WLAN bearer B110.

For this purpose, the I-WLAN bearer service manager 120 inquires to the admission and capability controller 130 whether the QoS to be negotiated with the PDG 400 is an adequate QoS or not. The admission and capability controller 130 determines adequacy of the QoS inquired by the I-WLAN bearer service manager 120 with reference to the QoS of the WLAN bearer B110 or the available resource of the WLAN bearer B110.

When the admission and capability controller 130 accepts the inquired QoS, the I-WLAN bearer service manager 120 requests the QoS accepted by the admission and capability controller 130 to the I-WLAN bearer service manager 420. At this time, the I-WLAN bearer service manager 120 uses a service of the WLAN bearer B110 when negotiating the QoS with the I-WLAN bearer service manager 420. In more detail, the I-WLAN bearer service manager 120 negotiates with the I-WLAN bearer service manager 420 by using the services of the WLAN bearer B110, the Wn bearer B120, and the Wp bearer B140.

The I-WLAN bearer service manager 420 inquires to the admission and capability controller 430 whether the admission and capability controller 430 accepts the QoS requested by the I-WLAN bearer service manager 120. The admission and capability controller 430 determines whether to accept the QoS requested by the bearer service manager 120 with reference to the available resource of the external bearer B160 or the QoS of the external bearer B160 and provides an internal primitive, including the determination of the admission and capability controller 430.

At this time, the admission and capability controller 430 refers to the resource allocated to the external bearer B160 or the QoS of the external bearer B160 because the QoS between the WLAN UE 100 and the PDG 400 depends on the QoS provided by the external bearer B160. When the admission and capability controller 430 rejects the requested QoS, the I-WLAN bearer service manager 120 and the I-WLAN bearer service manager 420 renegotiate the QoS. When the admission and capability controller 430 accepts the QoS, the I-WLAN bearer service manager 120 and the I-WLAN bearer service manager 420 establish an I-WLAN bearer B150. Then, the I-WLAN bearer service manager 120 and the I-WLAN bearer service manager 420 convert attributes of the I-WLAN bearer B150 and maintain the I-WLAN bearer B150.

When the I-WLAN bearer B150 is established, the I-WLAN bearer service manager 120 provides information on a QoS of the I-WLAN bearer B150 or information on a resource allocated to the I-WLAN bearer B150 to the admission and capability controller 130. Also, the I-WLAN bearer service manager 420 provides the information on the QoS of the I-WLAN bearer B150 and the information on the resource allocated to the I-WLAN bearer B150 to the admission and capability controller 430.

The IP bearer service manager 150 of the WLAN UE 100 negotiates a QoS with the PDG 400 for packet exchange between the IP bearer service manager 150 and the end terminal 500 of the external 3GPP packet-switched service network 3. When the negotiation is successful, the IP bearer service manager 150 and the IP bearer service manager 450 establish, manage, and maintain an IP bearer B170. The IP bearer B170 is used for packet exchange (i.e., end-to-end packet switch) between the WLAN UE 100 and the end terminal 500. The WLAN UE 100 establishes a plurality of IP bearers B170 respectively corresponding to a plurality of end terminals 500 for packet exchange. At this time, the WLAN UE 100 establishes the plurality of IP bearers B170 by negotiating a QoS with the PDG 400.

A method for QoS negotiation between the IP bearer server manager 150 of the WLAN UE 100 and the IP bearer service manager 450 of the packet data gateway 400 for establishing an IP bearer B170 will be described. The IP bearer B170 is used for packet exchange between the WLAN UE 100 and the end terminal 500.

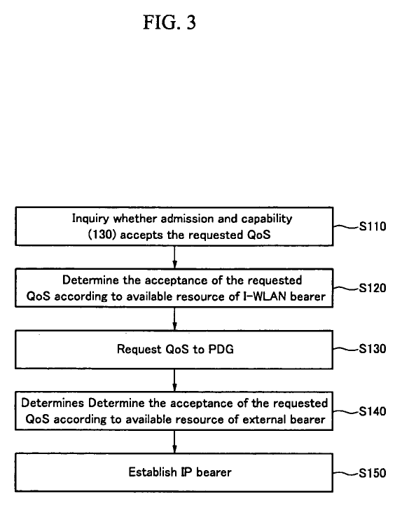

FIG. 3 is a flowchart of a method for a WLAN UE to establish the IP bearer B170.

The IP bearer service manager 150 inquires to the admission and capability controller 130 whether the admission and capability controller 130 accepts a QoS requested for establishing the IP bearer B170 in step S110. For this purpose, the IP bearer service manager 150 provides a primitive that includes a result of the requested QoS acceptance to the converter 140. The converter 140 converts the primitive into a primitive to be transmitted to the admission and capability controller 130, and provides the converted primitive to the I-WLAN bearer service manager 120. The I-WLAN bearer service manager 120 perceives that the received primitive is a primitive to be transmitted to the admission and capability controller 130, and transmits the primitive to the admission and capability controller 130.

The admission and capability controller 130 manages a resource allocated to the I-WLAN bearer B150. Therefore, the admission and capability controller 130 determines whether to accept the QoS requested by the IP bearer service manager 150 in accordance with an available resource of the I-WLAN bearer B150, in step S120. That is, when enough available resources of the I-WLAN bearer B150 exist such that the requested QoS can be supported, the admission and capability controller 130 accepts the QoS requested by the IP bearer service manager 150.

When the admission and capability controller 130 accepts the QoS requested by the IP bearer service manager 150, the IP bearer service manager 150 requests the QoS accepted by the admission and capability controller 130 to the PDG 400, in step S130.

In more detail, the IP bearer service manager 150 provides the converter 140 with a primitive that includes a request for the QoS to the PDG 400 for establishing the IP bearer B170. The converter 140 acknowledges that the primitive needs to be transmitted to the PDG 400, converts the primitive into a message to be transmitted to the PDG 400, and provides the message to the I-WLAN bearer service manager 120. The I-WLAN bearer service manager 120 forwards the message to the I-WLAN bearer service manager 420 through the I-WLAN bearer B150. The I-WLAN bearer service manager 420 provides the forwarded message to the converter 440.

Then, the converter 440 converts the message into a primitive in a format that can be read by the IP bearer service manager 450, and provides the conversion result to the IP bearer service manager 450. When the admission and capability controller 130 rejects the QoS requested by the IP bearer service manager 150, the IP bearer service manager 150 requests a new QoS to the admission and capability controller 130.

When receiving the primitive including the QoS request of the IP bearer service manager 150 from the converter 440, the IP bearer service manager 450 inquires to the admission and capability controller 430 about whether the admission and capability controller 430 accepts the requested QoS. The admission and capability controller 430 manages information on a resource allocated to the external bearer B160.

In addition, the admission and capability controller 430 determines whether to accept the QoS request of the IP bearer service manager 150 in accordance with an available resource of the external bearer B160 in step S140. At this time, the admission and capability controller 430 may determine whether to accept the QoS request of the IP bearer service manager 150 with reference to the available resource of the external bearer B160 and the available resource of the I-WLAN bearer B150. The admission and capability controller 430 provides the converter 440 with a primitive including a result of the determination on the requested QoS through the I-WLAN bearer service manager 420. The converter 440 converts the primitive into a format that can be read by the IP bearer service manager 450, and provides the converted primitive to the IP bearer service manager 450.

When the admission and capability controller 430 accepts the QoS request of the IP bearer service manager 150, the IP bearer service manager 150 and the IP bearer service manager 450 establish, manage, and maintain an IP bearer B170 that supports the QoS accepted by the admission and capability controller 430 in step S150. When the admission and capability controller 430 rejects the QoS request of the IP bearer service manager 150, the IP bearer service manager 150 requests a new QoS to the admission and capability controller 430.

A method for transmitting user packets will now be described.

The WLAN UE 100 and the end terminal 500 exchange user packets by using a service of the IP bearer B170. At this time, the IP bearer B170 uses services of the I-WLAN bearer B150 and the external bearer B160. In addition, the I-WLAN bearer B150 uses a service of the WLAN bearer B110, a service of the Wn bearer B120, and a service of the Wp bearer B140.

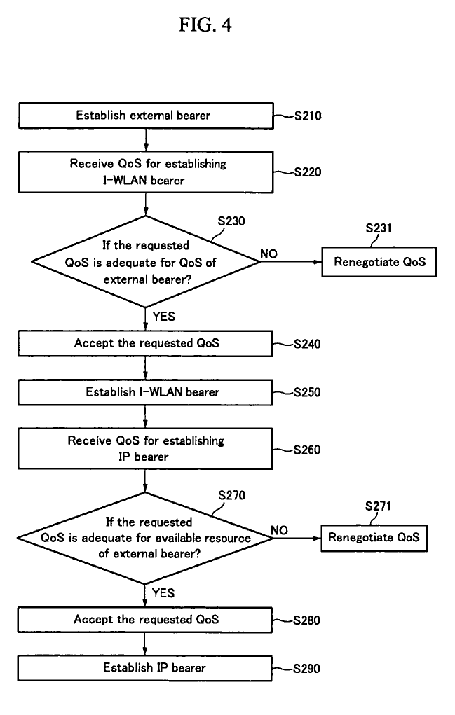

A QoS negotiation method of the PDG 400 according to an exemplary embodiment of the present invention will be described with reference to FIG. 4.

FIG. 4 is a flowchart of a QoS negotiation method of a packet data gateway according to the exemplary embodiment of the present invention.

The external bearer service manager 460 of the PDG 400 establishes an external bearer for packet exchange with an end terminal in step S210.

Subsequently, the WLAN UE 100 requests a QoS for establishing the I-WLAN bearer B150 from the I-WLAN bearer service manager 420, and the I-WLAN bearer service manager 420 receives the QoS requests from the WLAN UE 100 in step S220.

Then, the admission and capability controller 430 determines whether the requested QoS is adequate for a QoS of the external bearer in step S230, and accepts the request when a result of the determination shows that it is adequate in step S240. When the requested QoS is inadequate for the QoS of the external bearer, the WLAN UE 100 and the PDG 400 renegotiate a QoS for establishing the I-WLAN bearer B150.

When the admission and capability controller 430 accepts the requested QoS of the WLAN UE 100, the I-WLAN bearer service manager 420 establishes the I-WLAN bearer in step S250.

Subsequently, the I-WLAN bearer service manager 420 receives the QoS requested by the WLAN UE 100 for establishing the IP bearer B170 from the WLAN UE 100 through the I-WLAN bearer in step S260.

The admission and capability controller 430 determines whether the QoS requested by the WLAN UE 100 for establishing the IP bearer B170 is adequate for the available resource of the external bearer B160 in step S270 and accepts the QoS requested by the WLAN UE 100 when it is adequate in step S280. At this time, the admission and capability controller 430 further determines whether the QoS requested by the WLAN UE 100 is adequate for the available resource of the I-WLAN bearer B150 and accepts the QoS request of the WLAN UE 100 when it is adequate. When the QoS requested by the WLAN UE 100 is inadequate for the available resource of the external bearer B160, the WLAN UE 100 and the PDG 400 renegotiate a QoS for establishing the IP bearer B170.

When the admission and capability controller 430 accepts the QoS requested by the WLAN UE 100, the IP bearer service manager 450 establishes the IP bearer B170 in step S290.

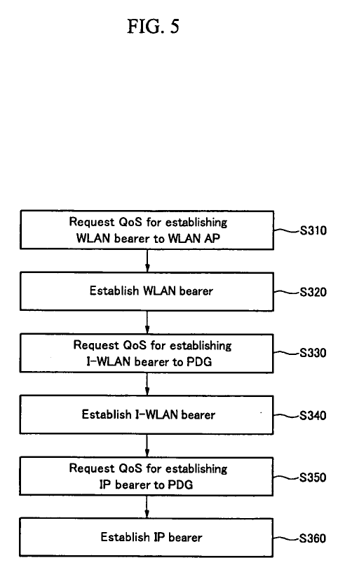

A method for the WLAN UE 100 to negotiate a QoS according to an exemplary embodiment of the present invention will be described with reference to FIG. 5.

FIG. 5 is a flowchart showing a method of the WLAN UE to negotiate a QoS according to an exemplary embodiment of the present invention, which will now be described.

The WLAN bearer service manager 110 of the WLAN UE 100 requests a QoS for establishing the WLAN bearer B110 from the WLAN AP 200 in step S310.

When the WLAN access point 300 accepts the QoS, the WLAN bearer service manager 110 establishes the WLAN bearer B110 for supporting the QoS in step S320.

Subsequently, the I-WLAN bearer service manager 120 requests a QoS for establishing the I-WLAN bearer B150 from the PDG 400 by using a service of the WLAN bearer B110 in step S330. At this time, the I-WLAN bearer service manager 120 determines a QoS for establishing the I-WLAN bearer B150 in accordance with an available resource of the WLAN bearer B110 and then requests the determined QoS from the PDG 400.

When the PDG 400 accepts the QoS, the I-WLAN bearer service manager 120 establishes an I-WLAN bearer for supporting the QoS in step S340.

The IP bearer service manager 150 requests a QoS for establishing the IP bearer B170 from the PDG 400 by using a service of the I-WLAN bearer B150 in step S350. At this time, the IP bearer service manager 150 determines a QoS for establishing the IP bearer B170 in accordance with an available resource of the I-WLAN bearer B150 and then requests the determined QoS from the PDG 400.

When the PDG 400 accepts the QoS for establishing the IP bearer B170, the IP bearer service manager 150 establishes the IP bearer B170 for supporting the QoS in step S360.

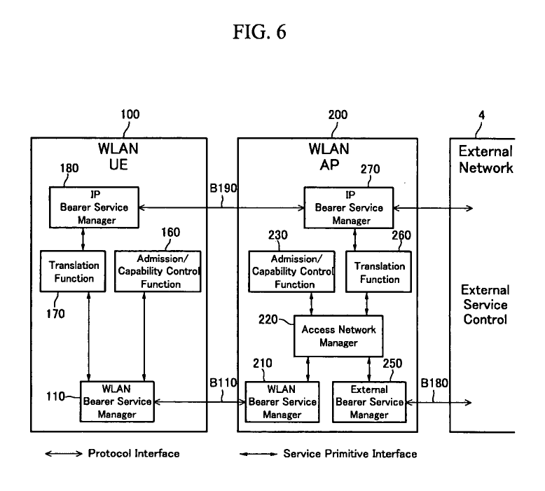

A QoS management function for establishing a WLAN direct IP connection according to an exemplary embodiment of the present invention will be described with reference to FIG. 6.

FIG. 6 shows the QoS management function for establishing the WLAN direct IP connection according to the exemplary embodiment of the present invention.

As shown in FIG. 6, the WLAN UE 100 further includes an admission and capability controller 160, a converter 170, and an IP bearer service manager 180. In addition, the WLAN access point 200 further includes an external bearer service manager 250, a converter 260, and an IP bearer service manager 270.

Interfaces between constituent elements of the WLAN UE 100 are as follows. The admission and capability controller 160 communicates with the WLAN bearer service manager 110 by using an internal service primitive. The converter 170 communicates with the WLAN bearer service manager 110 and the IP bearer service manager 180 by using an internal service primitive.

Interfaces between constituent elements of the WLAN AP 200 are as follows. The access network manager 220 communicates with the external bearer service manager 250 and the converter 260 by using an internal service primitive. The converter 260 communicates with the IP bearer service manager 270 by using an internal service primitive.

The WLAN bearer service manager 110 and the WLAN bearer service manager 210 negotiate a QoS and establish a WLAN bearer B110 for supporting the negotiated QoS in the same way as previously described. Therefore, a description related thereto will not be further provided. When the WLAN bearer B110 is established, the admission and capability controller 160 and the admission and capability controller 230 respectively manage resources allocated to the WLAN bearer B110.

The converter 170 and the converter 260 convert a message that corresponds to an internal service primitive and an external service signaling.

The external bearer service manager 250 of the WLAN AP 200 establishes, manages, and maintains an external bearer B180 used for packet exchange between the WLAN AP 200 and the end terminal 700 of the Internet. The admission and capability controller 230 manages a resource allocated to the external bearer B180.

A method for establishing an IP bearer B190 used for packet exchange between the WLAN UE 100 and the end terminal 700 will now be described.

The IP bearer service manager 180 inquires to the admission and capability controller 160 about adequacy of a QoS for establishing the IP bearer B190. The admission and capability controller 160 determines whether the QoS requested by the IP bearer service manager 180 is adequate in accordance with an available resource of the WLAN bearer B110.

When the admission and capability controller 160 determines that the QoS is adequate, the IP bearer service manager 180 requests the determined QoS from the IP bearer service manager 270 of the WLAN AP 200. At this time, the IP bearer service manager 180 requests the QoS from the WLAN AP 200 by using a service of the WLAN bearer B110, and the request is converted into an internal service primitive by the converter and transmitted to the IP bearer service manager 270.

When receiving the QoS request from the IP bearer service manager 180, the IP bearer service manager 270 inquires to the admission and capability controller 230 whether the admission and capability controller 230 accepts the requested QoS. The admission and capability controller 230 determines whether to accept the QoS in accordance with an available resource of the external bearer B180. At this time, the admission and capability controller 230 determines the acceptance of the QoS with further reference to the available resource of the WLAN bearer B110.

When the admission and capability controller 230 accepts the QoS for establishing the IP bearer B190, the IP bearer service manager 180 and the IP bearer service manager 270 establish, manage, and maintain an IP bearer B190 for supporting the QoS.

The above-described exemplary embodiment of the present invention may be realized by an apparatus and a method, but it may also be realized by a program that realizes functions corresponding to configurations of the exemplary embodiment or a recording medium that records the program.

Such a realization can be easily performed by a person skilled in the art.

While this invention has been described in connection with what is presently considered to be a practical exemplary embodiment, it is to be understood that the invention is not limited to the disclosed embodiment, but, on the contrary, is intended to cover various modifications and equivalent arrangements included within the spirit and scope of the appended claims.

1. A device that enables communication between a core network and a packet switched service network, the core network connecting a wireless access network and the packet switched service network, the device comprising:
a first bearer manager for managing a first bearer for packet exchange with an end terminal included in the packet switched service network;
a second bearer manager for managing a second bearer for packet exchange with a terminal accessing the wireless access network;
a third bearer manager for managing a third bearer for packet exchange between the terminal and the end terminal; and
a controller for determining whether to accept a first QoS requested by the terminal for establishing the third bearer through the second bearer in accordance with an available resource of the first bearer.

2. The device of claim 1, wherein the controller determines whether to accept the first QoS in accordance with available resources of the first and second bearers.

3. The device of claim 2, wherein the third bearer manager establishes the third bearer when the controller accepts the first QoS request of the terminal.

4. The device of claim 3, wherein:
the controller determines whether to accept a second QoS requested by the terminal for establishing the second bearer in accordance with the QoS of the first bearer, and
the second bearer manager establishes the second bearer when the controller accepts the second QoS request of the terminal.

5. The device of claim 4, further comprising a converter for enabling communication between the second bearer manager and the third bearer manager, and
wherein the second bearer manager receives a message including the first QoS request of the terminal, and
the converter converts the message into an internal primitive and provides the primitive to the second bearer manager.

6. The device of claim 5, wherein the controller provides a first primitive that includes whether the first QoS requested by the terminal is accepted to the second bearer manager,
the second bearer manager provides the first primitive to the converter, and
the converter converts the first primitive into a format that can be translated by the third bearer and provides a result of the conversion to the third bearer manager.

7. The device of claim 6, further comprising a fourth bearer manager for managing a fourth bearer established for packet exchange with the gateway that enables communication between the wireless access network and the core network.

8. A quality of service (QoS) negotiation method of a gateway for enabling communication between a core network and a packet switched service network, the core network connecting a wireless access network and the packet switched service network, the QoS negotiation method comprising:
establishing a first bearer for packet exchange with an end terminal included in the packet switched service network;
receiving a first QoS requested by a terminal for establishing a second bearer for packet exchange with the gateway, the terminal accessing the wireless access network;
accepting the first QoS when the first QoS is adequate for QoS of the first bearer; and
establishing a second bearer when the first QoS is accepted.

9. The QoS negotiation method of claim 8, further comprising:
receiving a second QoS requested by the terminal for establishing a third bearer for packet exchange with the end terminal through the second bearer;
accepting the second QoS when the second QoS is adequate for an available resource of the first bearer; and
establishing the third bearer when the second QoS is accepted.

10. The QoS negotiation method of claim 9, wherein the second QoS is accepted when the second QoS is adequate for the available resource of the first bearer and an available resource of the second bearer.

11. A terminal that exchanges a packet with a packet switched service network connected with a wireless access network through a core network, the terminal comprising:
a first bearer for managing a first bearer for packet exchange with an end terminal included in the packet switched service network;
a second bearer manager for managing a second bearer for packet exchange with an end terminal included in the packet switched service network; and
a controller for managing a resource allocated to the first bearer,
wherein the second bearer manager inquires to the controller whether to accept the first QoS for establishing the second bearer,
the controller determines whether to accept the first QoS in accordance with an available resource of the first bearer, and
the second bearer manager requests the first QoS from the gateway through the first bearer when the controller accepts the first QoS.

12. The terminal of claim 11, wherein the second bearer manager establishes the second bearer when the gateway accepts the first QoS.

13. The terminal of claim 12, further comprising
a third bearer manager for managing a third bearer for packet exchange with a wireless access device included in the wireless access network,
wherein the first bearer manager inquires to the controller whether to accept the second QoS for establishing the first bearer,
the controller determines whether to accept the second QoS in accordance with an available resource of the third bearer, and
the first bearer manager requests the second QoS from the gateway through the third bearer when the controller accepts the second QoS.

14. The terminal of claim 13, wherein the first bearer manager establishes the third bearer when the gateway accepts the second QoS.

15. The terminal of claim 14, wherein the third bearer manager requests a third QoS for establishing the third bearer from the wireless access device and establishes the third bearer when the wireless access device accepts the third QoS.

16. The terminal of claim 15, further comprising
a converter for enabling communication between the first bearer manager and the second bearer manager,
wherein, when receiving a primitive for requesting the first QoS from the second bearer manager to the gateway, the converter converts the primitive into a message and transmits the message to the gateway through the first bearer.

17. The terminal of claim 16, wherein when receiving a primitive for requesting whether to accept the first QoS from the second bearer manager, the controller transmits the primitive to the controller through the first bearer manager.

18. A quality of service (QoS) negotiation method of a terminal that exchanges a packet with a packet switched service network connected with a wireless access network through a core network, the QoS negotiation method comprising:
(a) requesting a first QoS from the wireless access device so as to establish a first bearer for packet exchange with a wireless access device included in the wireless access network;
(b) establishing the first bearer when the wireless access device accepts the first QoS;
(c) requesting a second QoS from a gateway through the first bearer so as to establish a second bearer for packet exchange with the gateway, the gateway enabling communication between the core network and the packet switched service network; and
(d) establishing the second bearer when the gateway accepts the second QoS.

19. The QoS negotiation method of claim 18, further comprising:
(e) requesting a third QoS from the gateway through the second bearer for establishing a third bearer for packet exchange with an end terminal included in the packet switched service network; and
(f) establishing the third bearer when the gateway accepts the third QoS.

20. The QoS negotiation method of claim 19, wherein (c) comprises:
determining the second QoS in accordance with an available resource of the first bearer; and
requesting the determined second QoS to the gateway through the first bearer.

21. The QoS negotiation method of claim 20, wherein (e) comprises:
determining the third QoS in accordance with an available resource of the second bearer; and
requesting the determined third QoS to the gateway through the first bearer.
